(19) United States
(12) Patent Application Publication
(10) Pub. No.: US 2020/0004526 A1
(43) Pub. Date: Jan. 2, 2020

(54) Method for Updating Firmware

(71) Applicant: Siemens Aktiengesellschaft, Muenchen (DE)

(72) Inventor: Christoph Weiler, Bretten (DE)

(21) Appl. No.: 16/457,227

(22) Filed: Jun. 28, 2019

(30) Foreign Application Priority Data
Jun. 29, 2018 (EP) 18180895

(51) Int. Cl. G06F 8/65

(52) U.S. Cl. CPC G06F 8/65

(57) ABSTRACT

A method for updating at least a part of the firmware of a device complex of a technical installation, in particular a production facility, wherein the device complex has a hierarchical structure that includes at least one device arranged at a higher level in the hierarchy and at least one device arranged at a lower level in the hierarchy, where the method includes assembling a suitable firmware package for the device complex and its at least two devices via an updating engine, transferring the assembled firmware package to the at least one hierarchically higher-level device, starting from the at least one hierarchically higher-level device, distributing the assembled firmware package to the at least one hierarchically lower-level device, and applying the assembled firmware package to update the at least one hierarchically higher-level device and the at least one hierarchically lower-level device.

### BACKGROUND OF THE INVENTION

### 1. Field of the Invention

The invention relates to a device complex of a technical installation and a method for updating at least a part of a firmware of the device complex of the technical installation.

### 2. Description of the Related Art

Current device complexes of a technical installation, especially Internet of Things (IoT) device complexes, require updates of their firmware at regular intervals in order to enable functional extensions to be implemented or security gaps to be closed. It is usual in this case for every single device of the device complex or every single component of a corresponding device to be updated individually. Today, devices/components are supplied with updates individually in a targeted manner. For each device or each component, there exists an individual firmware package that is transferred directly to the individual device or the individual component and installed there. This is associated with a high overhead, however.

Often, the device complexes are hierarchically structured, i.e., higher-ranking devices comprise a plurality of lower-ranking devices or subcomponents, to which further devices or components may be subordinate in turn. Between the devices or components of the different levels of a device complex there generally exists a dependence, such that changes in the firmware of a subordinate device have repercussions on the interaction with a higher-level device. It must be ensured that the firmware updates of the individual devices/components are performed such that, after the update, the entire hierarchically structured device complex starts up and functions again correctly. Otherwise, in the event of an incorrect update of the individual components/devices, a state of inconsistency can result, which may prevent or at least delay a continued operation of the device complex.

US 2015/095899 A1 describes a method for updating a software application in which the update is performed starting from a subcomponent of the application along a hierarchical upward sequence. In accordance with this method, the update data is distributed individually to the individual components of the software application which, as already explained above, is associated with an enormous overhead.

### SUMMARY OF THE INVENTION

It is an object of the invention to provide a method for updating at least a part of a firmware of a device complex of a technical installation which can be accomplished reliably with relatively low overhead.

This and other objects and advantages are achieved in accordance with the invention by a device complex of a technical installation and a method for updating at least a part of a firmware of the device complex of the technical installation, in particular a production facility, where the device complex has a hierarchical structure comprising at least one device arranged at a hierarchically higher level and at least one device arranged at a hierarchically lower level.

The method in accordance with the invention comprises the steps of a) assembling a suitable firmware package for the device complex and its at least two devices via an updating engine; b) transferring the firmware package to the at least one hierarchically higher-level device; c) starting from the at least one hierarchically higher-level device, distributing the firmware package to the at least one hierarchically lower-level device; and d) applying the firmware package to update the at least one hierarchically higher-level device and the at least one hierarchically lower-level device.

The term “firmware” is to be interpreted in a broad sense and denotes a piece of software that is or can be embedded in a device of the device complex. For example, the term “firmware” comprises an operating system that can be deployed in order to operate a device or a component of the device. The firmware does not have to be permanently installed on the device, however. It is also possible for the firmware (software) to be transferred new to the respective device while the device is being commissioned. In this case, it may be that the firmware is only temporarily resident on the device and is removed again from the device at the end of the operation of the device. For the method in accordance with the invention, it is therefore not essential whether the devices of the device complex already have firmware preinstalled. The term “updating” does not necessarily mean that firmware must already be resident on one or more (or each) of the devices before the method in accordance with the invention is performed.

The technical installation can be a facility from the process industry, such as a chemical, pharmaceutical or petrochemical plant, or a facility from the food and beverage industry. Also included within this definition are any facilities from the production industry, as well as factories in which, e.g., cars or goods of all kinds are produced. Technical installations suitable for implementing the method in accordance with the invention can also come from the energy production sector. Wind turbines, solar energy plants or power stations for producing energy are likewise encompassed within the term “technical installation”.

These installations in each case possess a control system or at least a computer-aided module for controlling and regulating the ongoing process or production. Part of the control system or control module or of a technical installation is at least one database or an archive in which historical data is stored. In the scenario presented, each installation is connected to a central data store outside of the enterprise infrastructure. Here, the central data store is part of a computer network with online-based storage and server services, which is commonly also referred to as a “cloud” or cloud platform. The data stored in the cloud is accessible online, so the technical installation also can have access via the internet to a central data archive in the cloud.

A device complex is a set of technical devices that, in the present case, consists of at least two devices. The device complex has a hierarchical structure representing a ranking in order of precedence of the devices associated with the complex. This may concern, for example, an information flow between the individual devices. A hierarchically lower-level device may be a sensor, for example, which communicates determined measured values to a hierarchically higher-level device that is formed as a transmitter.

The individual devices of the device complex may, but do not have to be in close spatial relationship with one another. It is possible that individual devices are not located in the same facility of the technical installation but are installed at separate locations that are connected to one another via cloud-based applications.

The updating engine can be, for example, a microcontroller that is located directly in the industrial installation. However, it may also be an external software service that is operated on a cloud server (inside or outside of the technical installation).

The essential point is that the firmware package assembled previously for the device complex is transferred to a single device within the complex. This device then coordinates the further distribution to devices arranged at a lower level in the hierarchy. With this, it can be ensured that an updating of the firmware of the device complex can proceed efficiently, reliably and with little investment of time and effort. The coordination can be accomplished directly via commands specified by the updating engine, which are executed by the hierarchically higher-level device. A command to a transmitter may, for example, be formulated as follows: “Distribute firmware package to sensor A, sensor B and sensor C”. In this scenario, the sensors A, B and C are hierarchically subordinate to the transmitter. The hierarchically higher-level device can, however, also independently determine some of the commands required for the distribution tasks. Thus, the updating engine could pass on the firmware package to the transmitter and simply instruct the transmitter to transfer the firmware to all sensors that correspond to a specific type. The transmitter can then itself determine how many sensors of the specific type are hierarchically subordinate to it and forward the firmware package to these.

It is not absolutely necessary for the “one hierarchically higher-level device” to be the device arranged at the highest level hierarchically in the device complex. Rather, the method in accordance with the invention can also be applied at lower hierarchy levels when, for example, only a subregion of the device complex is to be updated. It is also possible to select a plurality of devices of the device complex in parallel as hierarchically higher-level devices. For more detailed explanations in this regard, reference shall be made to the description of the exemplary embodiments.

Preferably, the following method steps are performed before the previously explained method steps a) to d) in order to determine the hierarchical structure: a) starting from the updating engine, establishing an information technology connection to the device complex; b) determining the hierarchical structure of the device complex; and c) communicating the hierarchical relationships to the updating engine.

In other words, the updating engine sets up a (data) connection to the device complex and interrogates the device complex concerning its hierarchical structure. “Setup”, in this context, does not necessarily mean a completely new setup of the connection. Rather, the (data) connection may of course already exist physically. The hierarchical structure is advantageously queried in a cascaded manner, i.e., each device determines the devices arranged hierarchically immediately below it. The devices, in turn, proceed in accordance with the same pattern with devices subordinate to them until the lowest hierarchy level has been reached. The determined information is then forwarded “upward” and transferred to the updating engine.

The interrogation can be initiated as necessary (on demand) when a new version of the firmware is available and the firmware package is to be assembled. However, it is also possible for the updating engine to poll the current hierarchical relationships within the device complex at regular intervals in rotation in order to have this information immediately available when needed. In this way, a delay to the process in the event of a temporary failure of the (data) connection between the updating engine and the device complex can be averted.

The updating engine can ascertain the hierarchical structure of the device complex from a database of the technical installation, the database preferably being formed as cloud-based. Alternatively to the above-explained direct ascertaining of the hierarchical structure, the structure can be determined from the device complex. However, it is also possible to retrieve the corresponding data from the database and compare it with newly ascertained data from the device complex in order to be able to detect possible changes and in a second step to conduct a check to verify whether the changes are also intended.

In an advantageous embodiment of the invention, the hierarchically higher-level device performs a filtering of the firmware package received from the updating engine. The filtering occurs in this case to the effect that the hierarchically higher-level device checks which part of the firmware package is provided for the at least one hierarchically lower-level device. The at least one hierarchically higher-level device then passes on only the filtered part of the firmware package to the at least one hierarchically lower-level device.

Particularly preferably, the at least one hierarchically lower-level device is updated at an earlier point in time than the at least one hierarchically higher-level device. In this case, the at least one hierarchically lower-level device transmits a message to the at least one hierarchically higher-level device to the effect that the at least one hierarchically higher-level device is informed via the message of whether the application of the firmware package in order to update the firmware of the at least one hierarchically lower-level device has been properly completed. As soon as the hierarchically higher-level device has received the positive completion message from the hierarchically lower-level device, the hierarchically higher-level device can commence updating its firmware. With this embodiment of the invention, it is ensured to a particular degree that the updating of the firmware of the individual devices of the device complex is proceeding in a reliable manner.

The hierarchically higher-level device advantageously forwards the message received from the at least one hierarchically lower-level device to the updating engine and/or to further hierarchically higher-level devices so that these also receive feedback concerning the status of the updating of the individual devices.

In the event that the application of the firmware package in order to update the firmware of the at least one hierarchically lower-level device has not been completed in the proper fashion, the at least one hierarchically higher-level device and/or the updating engine can transmit an instruction to the at least one hierarchically lower-level device. The purpose of the instruction in this case is to cause the at least one hierarchically lower-level device to roll back the application of the firmware package for updating the firmware of the at least one hierarchically lower-level device to terminate the error state.

It is also an object of the invention to provide a device complex of a technical installation, in particular a production facility, wherein the device complex has a hierarchical structure comprising at least one device arranged at a higher level in the hierarchy and at least one device arranged at a lower level in the hierarchy. The device complex is characterized in that the firmware of at least a part of the device complex has been updated at least once in accordance with a previously explained embodiment of the method in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention, as well as the manner in which these are achieved, will become clearer and more readily understandable in connection with the following description of the exemplary embodiments, which are explained in more detail with reference to the figures, in which:

FIG. 1 shows a schematic diagram of a device complex in accordance with the invention;

FIG. 2 shows a firmware package for updating the device complex shown in FIG. 1; and

FIG. 3 shows a flowchart for an updating process of the device complex of FIG. 1.

### DETAILED DESCRIPTION OF THE EXEMPLARY EMBODIMENTS

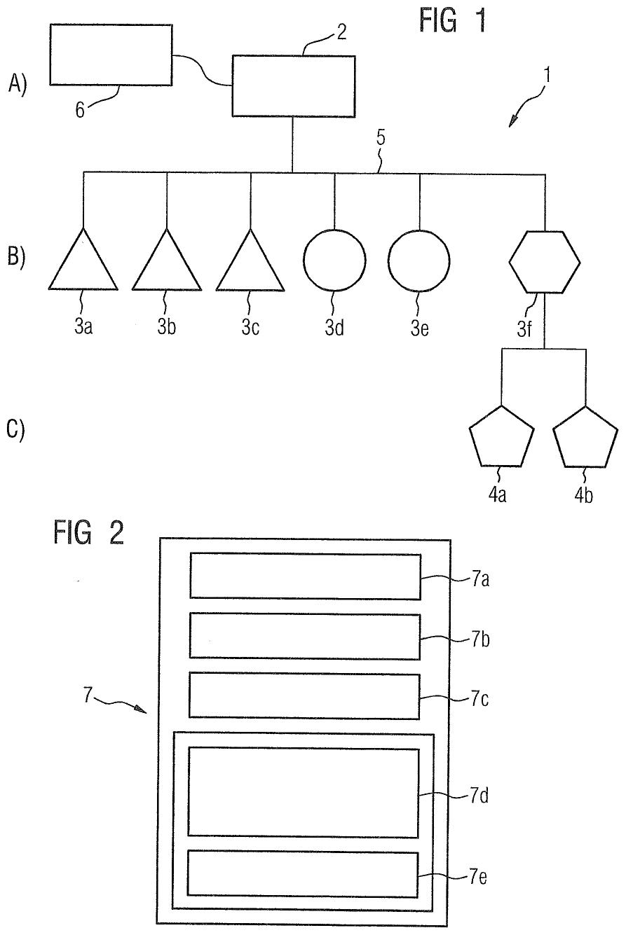

FIG. 1 shows a schematic diagram of a device complex 1. The device complex 1 has three hierarchy levels A, B, C. A transmitter 2 is disposed at the first hierarchy level A. At the second hierarchy level B, there are three sensors 3a, 3b, 3c of type I, two sensors 3d, 3e of type II and one sensor 3f of type III. At the third hierarchy level C there are two digital measuring transducers 4a, 4b, which are provided specifically for the sensor 3f of type III.

The individual devices 2, 3a, 3b, 3c, 3d, 3e, 3f, 4a, 4b are connected via data lines 5, which enable an exchange of data between the devices 2, 3a, 3b, 3c, 3d, 3e, 3f, 4a, 4b. The data lines can be wired or wireless connections 5.

Within the scope of the exemplary embodiment, each of the devices 3a, 3b, 3c, 3d, 3e, 3f, 4a, 4b transmits a unique identifier to the transmitter 2 as the component arranged at the hierarchically highest level of the device complex 1. The transmitter 2 forwards the information about the hierarchical structure of the device complex 1 to an updating engine 6 formed as a cloud-based service. The cloud-based service 6 is executable on a server within the framework of a cloud environment.

With the aid of the hierarchical structure of the device complex 1 communicated to it, the updating engine 6 builds a suitable firmware package 7, which is provided for the purpose of updating the firmware of the devices 2, 3a, 3b, 3c, 3d, 3e, 3f, 4a, 4b of the device complex 1. The configuration of the firmware package 7 is shown in FIG. 2, and comprises a firmware subpackage 7a for the transmitter 2, a firmware subpackage 7b for the sensors of type I, a firmware subpackage 7c for the sensors of type II, a firmware subpackage 7d for the sensors of type III, and a firmware subpackage 7e for the digital measuring transducers 4a, 4b.

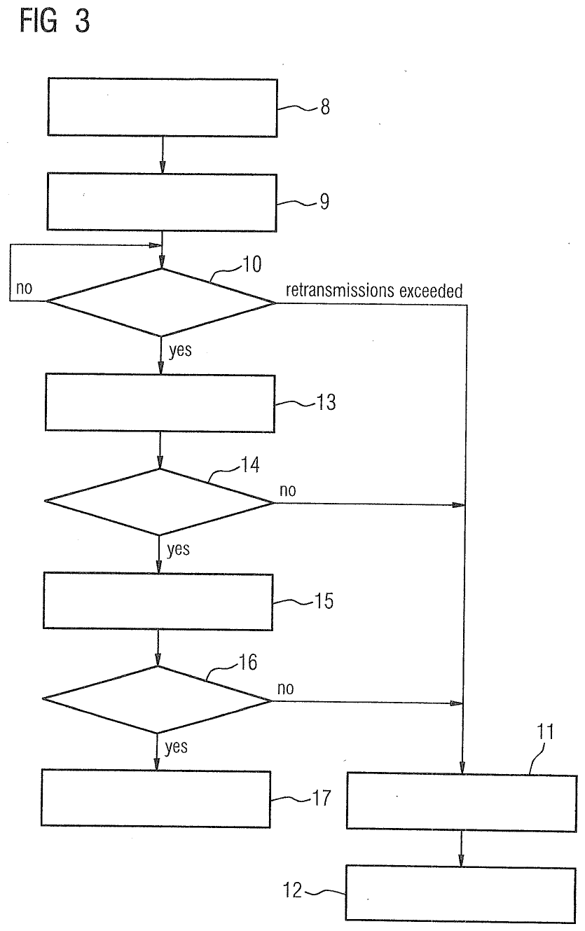

After the firmware package 7 has been assembled, it is transferred to the transmitter 2 as the device arranged at a hierarchically higher level than the sensors 3a, 3b, 3c, 3d, 3e, 3f and the measuring transducers 4a, 4b. FIG. 3 shows the further steps that are performed after the firmware package 7 has been received within the device complex 1.

In a first step 8, the firmware package 7 is disassembled by the transmitter 2 into the individual firmware subpackages 7a, 7b, 7c, 7d, 7e.

In the following second step 9, the firmware subpackages 7a, 7b, 7c, 7d, 7e are transferred, starting from the transmitter 2, to the individual devices 3a, 3b, 3c, 3d, 3e, 3f, 4a, 4b. In the process, the transmitter 2, as the hierarchically higher-level device, performs a filtering of the firmware package 7 received from the updating engine 6 or, as the case may be, of its firmware subpackages 7a, 7b, 7c, 7d, 7e. The information concerning which device 3a, 3b, 3c, 3d, 3e, 3f, 4a, 4b is to receive which firmware subpackage 7a, 7b, 7c, 7d, 7e is appended to the transmitted firmware package 7 by the updating engine 6.

In a third step 10, all of the devices 3a, 3b, 3c, 3d, 3e, 3f, 4a, 4b send an acknowledgment to the transmitter 2 to confirm that they have received the corresponding firmware subpackages 7a, 7b, 7c, 7d, 7e. In the event that an acknowledgment of said type has not been received from all of the devices 3a, 3b, 3c, 3d, 3e, 3f, 4a, 4b, after a certain time has elapsed the transmitter 2 retransmits the firmware subpackages 7a, 7b, 7c, 7d, 7e to the devices 3a, 3b, 3c, 3d, 3e, 3f, 4a, 4b. If a defined number of retransmissions of the firmware subpackages 7a, 7b, 7c, 7d, 7e has been exceeded, this leads to an abortion 11 of the update. In this case, the transmitter 2 sends an error message 12 to the updating engine 6.

In the event that an acknowledgment of the aforesaid type has been received by the transmitter 2 from all of the devices 3a, 3b, 3c, 3d, 3e, 3f, 4a, 4b, an update release is triggered in a fourth step 13 for all of the devices 3a, 3b, 3c, 3d, 3e, 3f, 4a, 4b that are subordinate to the transmitter 2.

In a fifth step 14, a check is conducted by each device 2, 3a, 3b, 3c, 3d, 3e, 3f to verify whether all updates of the respective firmware of the respective subordinate devices 3a, 3b, 3c, 3d, 3e, 3f, 4a, 4b have been completed successfully. If this is not the case, this leads to an abortion 11 of the update. In this event the transmitter 2 sends an error message 12 to the updating engine 6.

If all updates of the respective firmware of the respective subordinate devices 3a, 3b, 3c, 3d, 3e, 3f, 4a, 4b have been successfully completed, the hierarchically higher-level device 2, 3a, 3b, 3c, 3d, 3e, 3f performs an update of its own firmware in a sixth step 15.

In a seventh step 16, the device 2 arranged at the highest level in the hierarchy, in this case the transmitter 2, checks whether its updating of the firmware has been successfully completed. If this is not the case, this leads to an abortion 11 of the update. In this case, the transmitter 2 sends an error message 12 to the updating engine 6.

If the updating of its own firmware has been successfully completed by the transmitter 2, the transmitter 2 sends a notification 17 to the updating engine 6 to confirm that the updating of the firmware of the device complex 1 has been successfully terminated.

The described updating process in accordance with the invention is associated with a significantly reduced investment of time compared to conventional methods. At the same time, the risk of manual errors during the updating can be substantially reduced. Overall, this allows an updating rate for a firmware rollout of a device complex 1 to be considerably increased without generating a significant amount of additional overhead.

Although the invention has been illustrated and described in greater detail on the basis of the preferred exemplary embodiment, the invention is not limited by the disclosed example and other variations can be derived herefrom by the person skilled in the art without leaving the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for updating at least a part of firmware of a device complex of a technical installation, the device complex having a hierarchical structure comprising at least one device arranged at a hierarchically higher level and at least one device arranged at a hierarchically lower level, the method comprising:
a) assembling a firmware package for the device complex and at least two devices of the device complex via an updating engine;
b) transferring the assembled firmware package to the at least one hierarchically higher-level device;
c) starting from the at least one hierarchically higher-level device, distributing the assembled firmware package to the at least one hierarchically lower-level device; and
d) applying the assembled firmware package to update the at least one hierarchically higher-level device, and the at least one hierarchically lower-level device.

2. The method as claimed in claim 1, wherein, in order to determine a hierarchical structure of the device complex, the following method steps are performed before method steps a), b), c) and d) of 1:
a1) starting from the updating engine, establishing an information technology connection to the device complex;
b1) determining the hierarchical structure of the device complex; and
c) communicating the hierarchical relationships to the updating engine.

3. The method as claimed in claim 1, wherein the updating engine ascertains a hierarchical structure of the device complex from a database of the technical installation; and wherein the database is formed as a cloud-based database.

4. The method as claimed in claim 1, wherein the hierarchically higher-level device filters the assembled firmware package received from the updating engine by checking which part of the assembled firmware package is provided for the at least one hierarchically lower-level device; and wherein the at least one hierarchically higher-level device passes on only a filtered part of the assembled firmware package to the at least one hierarchically lower-level device.

5. The method as claimed in claim 1, wherein the at least one hierarchically lower-level device is updated at an earlier point in time than the at least one hierarchically higher-level device; and wherein the at least one hierarchically lower-level device transmits a message to the at least one hierarchically higher-level device to inform the at least one hierarchically higher-level device via the message whether the application of the assembled firmware package for updating the firmware of the at least one hierarchically lower-level device has been properly completed.

6. The method as claimed in claim 5, wherein the at least one hierarchically higher-level device forwards the message received from the at least one hierarchically lower-level device to at least one of (i) the updating engine and (ii) further hierarchically higher-level devices.

7. The method as claimed in claim 5, wherein in an event that the application of the firmware package in order to update the firmware of the at least one hierarchically lower-level device has not been properly completed, at least one of (i) the at least one hierarchically higher-level device and (ii) the updating engine transmit/transmits an instruction to the at least one hierarchically lower device such that the at least one hierarchically lower-level device rolls back application of the assembled firmware package for updating the firmware of the at least one hierarchically lower-level device.

8. The method as claimed in claim 6, wherein in an event that the application of the firmware package in order to update the firmware of the at least one hierarchically lower-level device has not been properly completed, at least one of (i) the at least one hierarchically higher-level device and (ii) the updating engine transmit/transmits an instruction to the at least one hierarchically lower device such that the at least one hierarchically lower-level device rolls back application of the assembled firmware package for updating the firmware of the at least one hierarchically lower-level device.

9. The method as claimed in claim 1, wherein the technical installation is a production facility.

10. A device complex of a technical installation, comprising:
an updating engine;
a transmitter;
a hierarchical structure comprising at least one device arranged at a higher level in a hierarchy; and
at least one device arranged at a lower level in the hierarchy, wherein firmware of at least a part of the device complex is updated
at least once by:
a) assembling a firmware package for the device complex and at least two devices of the device complex via the updating engine;
b) transferring the assembled firmware package to the at least one hierarchically higher-level device;
c) starting from the at least one hierarchically higher-level device, distributing the assembled firmware package to the at least one hierarchically lower-level device; and
d) applying the assembled firmware package to update the at least one hierarchically higher-level device, and the at least one hierarchically lower-level device.

11. The device complex as claimed in claim 10, wherein the technical installation is a production facility,
